(19) United States
(12) Patent Application Publication
(10) Pub. No.: US 2026/0247431 A1
(43) Pub. Date: Aug. 20, 2026

(54) SYSTEMS, APPARATUSES AND METHODS FOR ENHANCING MULTI-ACCESS POINT COORDINATION WITH NON-PRIMARY CHANNEL ACCESS

(71) Applicant: HUAWEI TECHNOLOGIES CO., LTD., SHENZHEN (CN)

(72) Inventors: Mahmoud HASABELNABY, Kanata (CA); Osama ABOUL-MAGD, Kanata (CA); Jung Hoon SUH, Kanata (CA); Yan XIN, Kanata (CA); Kwok Shum AU, Kanata (CA); Abdalla Mohamed Abdelaziz Mahmoud HUSSEIN, Kanata (CA); Sara NOROUZI, Kanata (CA)

(73) Assignee: HUAWEI TECHNOLOGIES CO., LTD., SHENZHEN (CN)

(21) Appl. No.: 19/301,592

(22) Filed: Aug. 15, 2025

Related U.S. Application Data
(60) Provisional application No. 63/760,431, filed on Feb. 19, 2025.

(51) Int. Cl. H04W 74/06; H04W 8/22; H04W 28/02; H04W 74/0816

(52) U.S. Cl. CPC H04W 74/06; H04W 8/22; H04W 28/0278; H04W 74/0816

(57) ABSTRACT

There is provided systems, methods and apparatuses for integrating non-primary channel access (NPCA) into the multi-access point (MAP) coordination transmission phase. This integration can enable more APs to utilize the available transmission opportunity (TXOP) duration and increase resource allocation flexibility.

### CROSS-REFERENCE TO RELATED APPLICATIONS

This application claims the benefit of priority to U.S. Provisional Patent Application No. 63/760,431, filed Feb. 19, 2025, the contents of which are incorporated herein by reference in its entirety.

### FIELD OF THE DISCLOSURE

The present disclosure relates generally to communication systems, apparatuses, methods, and non-transitory computer-readable storage devices, and in particular to systems, apparatuses and methods for enhancing multi-access point coordination with non-primary channel access.

### BACKGROUND

The IEEE 802.11 standard defines a multi-access point (MAP) coordination framework is designed to optimize the performance of wireless networks by facilitating efficient resource sharing and management across multiple access points (APs). This framework supports both transmission opportunity (TXOP)-based coordination schemes, for example coordinated spatial reuse (Co-SR), coordinated beamforming (Co-BF), coordinated orthogonal frequency division multiple access (Co-OFDMA), and coordinated time division multiple access (Co-TDMA), as well as service period (SP)-based coordination schemes like coordinated restricted target wake time (CR-TWT).

The MAP coordination process includes: 1) MAP discovery, which involves identifying and discovering APs that are candidates for coordination; 2) MAP coordination negotiation & agreement setting, which establishes agreements on coordination mechanisms, including roles and responsibilities of participating APs; and 3) MAP coordinated transmission phase, where coordinated transmissions are executed based on the negotiated agreements.

However, despite its flexibility, the MAP coordination framework faces inherent limitations due to constraints imposed by specific coordination schemes. For example, Co-SR and Co-BF are restricted to a maximum of two coordinating APs, with Co-BF capable of serving up to four non-AP stations (STAs) in total. Further there are restrictions that mandate that the trigger frame initiating concurrent Co-SR/Co-BF transmissions must carry information such as the duration of the data physical protocol data unit (PPDU) transmitted by both the sharing and shared APs, with both durations being identical. Yet further current restrictions define a procedure for a TXOP owner AP to announce its intention to share part of its TXOP for Co-TDMA operations, which is achieved through an initial control frame (ICF) sent at the beginning of the TXOP, wherein the ICF is for polling potential sharing APs to gauge their interest.

However, these predefined resource allocations may not always align with the real-time requirements of shared APs, especially in dynamic traffic environments. Variations in traffic demands across different basic service sets (BSSs) can lead to mismatches between the resources allocated by the MAP coordination scheme and the actual needs of the APs involved. The current resource constraint, for example including limitations on shared TXOP duration, the number of coordinating APs, and the number of served non-AP STAs, can hinder the scalability and efficiency of certain coordination schemes. This, in turn, reduces the overall performance gains of the MAP coordination process.

Therefore, there is a need for a method, apparatus and system for wireless communication that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of embodiments of the present disclosure is to provide a method, system and apparatus for enhancing multi-access point coordination with non-primary channel access.

According to an aspect of the present disclosure, there is provided a method for multi-access point (MAP) coordination. The method includes transmitting, by a sharing access point (AP) to shared AP(s), a MAP polling initial control frame (ICF), the MAP ICF indicative of a request regarding participation of the sharing AP in MAP coordination and non-primary channel access (NPCA). The method further including receiving, by the sharing AP from the shared AP, a MAP polling initial control response (ICR), the MAP ICR indicative of acceptance or denial of one or more of MAP coordination and NPCA, by the shared AP.

In some embodiments, the MAP ICR further includes MAP coordination (MAPC) capabilities associated with the shared AP.

In some embodiments, upon receipt, by the sharing AP, of a MAP ICR indicative of acceptance of one or more of MAP coordination and NPCA, the method further includes transmitting, by the sharing AP to the shared AP(s), a MAP announcement frame, the MAP announcement frame indicative of parameters associated with the selected MAP coordination scheme or NPCA.

In some embodiments, upon receipt by the sharing AP, of the MAP announcement frame, the method further includes transmitting, by the shared AP to a station (STA) associated with the shared AP, a NPCA trigger frame.

In some embodiments, upon receipt by the sharing AP, of the MAP announcement frame, the method further includes transmitting, by the shared AP to a station (STA) associated with the shared AP, a Co-OFDMA trigger frame.

In some embodiments, the NPCA trigger frame is indicative of whether NPCA switching is enabled or disabled, the NPCA switching start time and the NPCA duration.

In some embodiments, the MAP coordination scheme is selected from any one of coordinated beamforming (Co-BF), coordinated time division multiple access (Co-TDMA), coordinated orthogonal frequency division multiple access (Co-OFDMA), and coordinated spatial reuse (Co-SR).

In some embodiments, when multiple shared access points (APs) are to be triggered to switch to respective non-primary channel access (NPCA) primary channels, the sharing AP only triggers shared APs whose respective NPCA primary channels do not overlap.

In some embodiments, the sharing AP assigns different resource unit (RU) allocations for transmission of each of the AP responses to the MAP announcement frame to allow multiple shared APs to respond simultaneously to the MAP announcement frame.

In some embodiments, the MAP announcement frame is configured as a buffer status report poll (BSRP) frame, a multi-user request-to-send (MU-RTS) trigger frame, or a new type trigger frame.

In some embodiments, when another shared AP receives the MAP polling ICF and the another shared AP is unresponsive to the MAP polling ICF, the method further includes switching, by the another shared AP, to a NPCA primary channel associated with the another shared AP, prior to transmission of a MAP announcement frame by the sharing AP.

In some embodiments, the method further includes detecting, by the non-AP STAs, an overlying basic service set (OBSS) control frame exchange in order to initiate switching to the NPCA primary channel.

In some embodiments, the method further includes detecting, by the shared AP and the non-AP STAs, a NPCA duration that matches a transmission opportunity (TXOP) duration specified in the MAP ICF.

In some embodiments, another shared AP receives the MAP ICF and the another shared AP is responsive to the MAP polling ICF, by sending the MAP ICR indicating its unwillingness to participate, the method further includes refraining from switching, by the another shared AP and the non-AP STAs associated with the another shared AP, to a NPCA primary channel associated with the another shared AP.

In some embodiments, the indicating of unwilling to participate includes setting an availability indication bit within the MAP ICR to zero.

In some embodiments, the MAP ICR further includes one or more of: a MAP coordination readiness indication, required duration, bandwidth, transmit power, traffic indicator/access category (TID/AC), a low-latency indication, number of non-AP STAs the shared AP plans to serve, and a preferred MAP coordination scheme.

In some embodiments, neighboring APs with overlapping NPCA primary channels may coordinate with each other to recommend updating their NPCA primary channel to non-overlapping channel locations.

In some embodiments, the coordination between the neighboring APs to update their NPCA primary channel update is carried out by exchanging public action frames.

In some embodiments, the public action frames exchanged between neighboring APs may carry a MAP parameter negotiation/notify element.

According to one aspect of this disclosure, there is provided one or more circuits such as one or more processors for performing the above-described methods.

According to one aspect of this disclosure, there is provided one or more processors functionally connected to one or more memories for performing the above-described methods.

According to one aspect of this disclosure, there is provided an apparatus comprising: one or more processors functionally connected to one or more memories for performing the above-described methods.

According to one aspect of this disclosure, there is provided one or more non-transitory computer-readable storage devices comprising computer-executable instructions, wherein the instructions, when executed, cause one or more circuits to perform the above-described methods.

According to one aspect of this disclosure, there is provided an apparatus, and configured to perform any one of the above-mentioned methods and their embodiments. Specifically, the apparatus includes one or more units configured to perform any one of the above-mentioned methods and their embodiments.

According to one aspect of this disclosure, there is provided a computer-readable storage medium. The computer-readable storage medium stores a computer program, and when the computer program is executed by an apparatus, the apparatus is enabled to implement any one of the above-mentioned methods and their embodiments.

According to one aspect of this disclosure, there is provided a computer program product including one or more instructions. When the instructions are executed by an apparatus such as a computer, the apparatus is enabled to implement any one of the above-mentioned methods and their embodiments.

According to one aspect of this disclosure, there is provided a computer program. When the computer program is executed by a computer, an apparatus is enabled to implement any one of above-mentioned methods and their embodiments.

According to one aspect of this disclosure, there is provided a communication system. The communication system includes a first communication-node and/or a second communication-node, the first communication-node is configured to perform the methods regarding with the first communication-node as stated above, and the second communication-node is configured to perform the methods regarding with the second communication-node as stated above.

According to one aspect of this disclosure, there is provided an apparatus for implementing the methods in any possible implementation of the foregoing aspects.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which:

FIG. 1 is a simplified schematic diagram showing a communication system, according to some embodiments of this disclosure.

FIG. 2 is a simplified schematic diagram of an access point (AP) of the communication network of the communication system shown in FIG. 1.

FIG. 3 is a simplified schematic diagram of a station (STA) of the communication system shown in FIG. 1.

FIG. 4 illustrates locations of potential non-primary channel access (NPCA) channels relative to a basic service set (BSS) primary channel.

FIG. 5 illustrates a process for multi-access point (MAP) polling and announcement relative to access point (AP) transmission opportunity (TXOP) duration, according to embodiments of the present disclosure.

FIG. 6 illustrates a process for MAP polling for shared APs including initial control frame (ICF) and initial control response (ICR), according to embodiments of the present disclosure.

FIG. 7 illustrates a process for MAP polling and MAP announcement wherein a polled AP ops into MAP coordination, according to embodiments of the present disclosure.

FIG. 8A illustrates a format of a buffer status report poll (BSRP) trigger frame configuration, according to embodiments of the present disclosure.

FIG. 8B illustrates a format of an extended ultra-high reliability (UHR) variant user field, according to embodiments of the present disclosure.

FIG. 9 illustrates a process for MAP coordinated time division multiple access (Co-TDMA) with NPCA, according to embodiments of the present disclosure.

FIG. 10 illustrates a process for MAP coordinated beam forming (Co-BF) with NPCA, according to embodiments of the present disclosure.

FIG. 11 illustrates a process for MAP Co-TDMA and Co-BF with NPCA, according to embodiments of the present disclosure.

FIG. 12A illustrates a format of a public action frame for parameters negotiation/notify, according to embodiments of the present disclosure.

FIG. 12B illustrates a format of MAP parameters negotiation element, according to embodiments of the present disclosure.

FIG. 13 illustrates a process for MAP polling for shared APs including ICF and ICR, wherein a polled AP declines MAP coordination while choosing NPCA, according to embodiments of the present disclosure.

FIG. 14 illustrates a process for MAP Co-TDMA and Co-BF with NPCA, wherein a polled AP declines MAP coordination while choosing NPCA, according to embodiments of the present disclosure.

FIG. 15 illustrates a process for MAP polling for shared APs including ICF and ICR, wherein a polled AP declines MAP coordination and further declines NPCA, according to embodiments of the present disclosure.

FIG. 16 illustrates a method for multi-access point (MAP) coordination, according to embodiments of the present disclosure.

It will be noted that throughout the appended drawings, like features are identified by like reference numerals.

### DETAILED DESCRIPTION

Embodiments disclosed herein relate to systems, apparatuses, methods, and non-transitory computer-readable storage devices for wireless communication. The wireless communication systems, apparatuses, and methods disclosed herein may be any suitable systems, apparatuses, and methods for transmitting wireless signals. Examples of such systems may be wireless local-area network (WLAN) ultra-high reliability (UHR) systems (for example, IEEE 802.11bn or Wi-Fi® 8 systems), 5G or 6G wireless mobile communication systems, and the like.

Initially, in order to meet throughput and latency requirements and further utilize the channel and manage overlapping basic service set (OBSS) interference, NPCA was proposed as a potential feature in IEEE 802.11bn. Both the AP and its associated non-AP STAs must agree on one NPCA primary channel location and bandwidth. NPCA allows for channel access on one of the secondary channels of the BSS when the primary channel is busy.

In order to address challenges in the prior art, the instant application discloses the integration of additional IEEE 802.11bn features, such as non-primary channel access (NPCA), into the MAP coordination framework.

It has been realized that integrating NPCA into the multi-access point (MAP) coordination transmission phase can enable more APs to utilize the available transmission opportunity (TXOP) duration and increase resource allocation flexibility. These enhancements can significantly improve the efficiency and applicability of the MAP coordination process across diverse network scenarios.

Embodiments of the instant application address several technical problems inherent in the existing MAP Coordination framework. Embodiments aim to alleviate MAP coordination scalability constraints. This can include overcoming the limitations on the number of coordinating APs and the maximum number of supported non-AP STAs, imposed by some MAP coordination schemes, for example Co-SR and Co-BF, in order to improve network scalability in dense environments. Embodiments aim to alleviate inefficient resource utilization, which may be provided by enhancing the flexibility of resource allocation mechanisms to better match dynamic traffic demands and prevent resource underutilization or congestion. Embodiments aim to alleviate the underutilization of non-primary channels, wherein NPCA integration with MAP coordination may provide improved channel utilization and interference management. In this manner the present disclosure seeks to enhance the performance, scalability, and adaptability of the MAP coordination framework, thereby supporting more efficient wireless network operations.

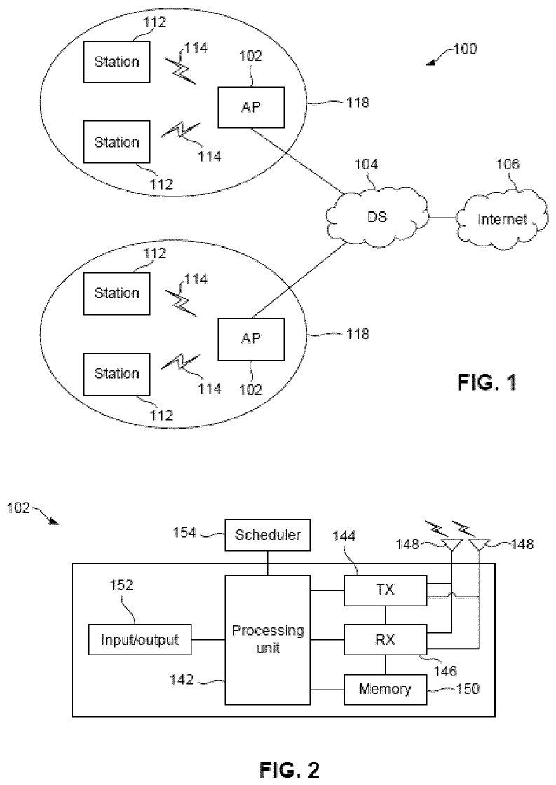

Turning now to FIG. 1, a communication system according to some embodiments of this disclosure is shown and is generally identified using reference numeral 100. As an example, the communication system 100 may be a Wi-Fi® system built under relevant standards such as IEEE 802.11 standard. As shown, the communication system 100 includes a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet protocol (IP), transmission control protocol (TCP), user datagram protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 includes at least one processing unit 142 (also denoted at least one “processor”), at least one transmitter (Tx) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

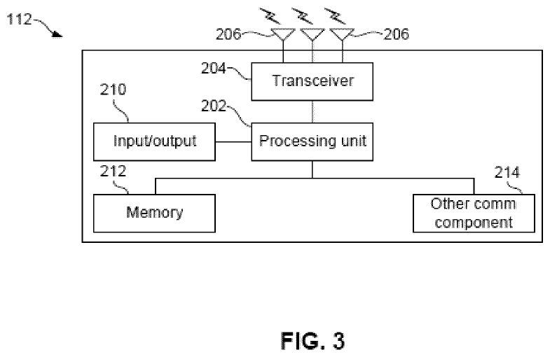

Herein, with reference to FIG. 3, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

As previously noted, it has been realized that integrating NPCA into the multi-access point (MAP) coordination transmission phase can enable more APs to utilize the available transmission opportunity (TXOP) duration and increase resource allocation flexibility. These enhancements can significantly improve the efficiency and applicability of the MAP coordination process across diverse network scenarios.

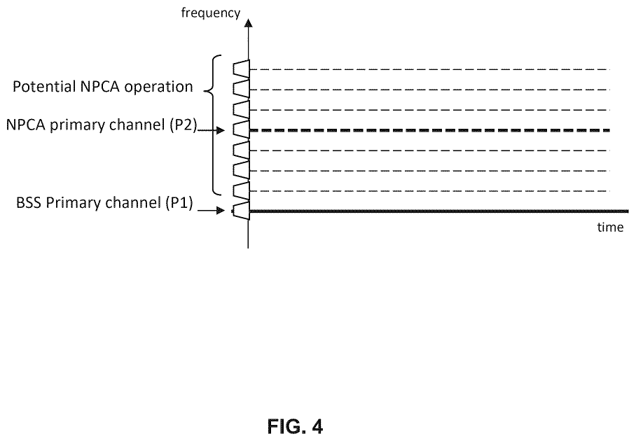

FIG. 4 illustrates locations of potential non-primary channel access (NPCA) channels relative to a basic service set (BSS) primary channel. Having regard to FIG. 4, there are illustrated potential one or more secondary channels of the BSS that may be suitable channel access while the primary channel is being used.

According to embodiments, at the beginning of each multi-access point coordination (MAPC) transmission opportunity (TXOP) sharing, the sharing access point (AP) and shared AP(s) must have the following sequential exchange of initial control frames (ICF) and initial control responses (ICR). The particular frames are termed MAP polling ICF frames, MAP polling ICR frames, MAP announcement ICF frames and MAP scheme-specific ICR frame, for example when coordinated beam forming (Co-BF) or coordinated orthogonal frequency-division multiple access (Co-OFDMA) or non-primary channel access (NPCA) is selected. In some embodiments, MAP announcement ICF frames and MAP scheme-specific ICR frame may be not required for other MAPC schemes, for example coordinated time division multiple access (Co-TDMA) or coordinated spatial reuse (Co-SR).

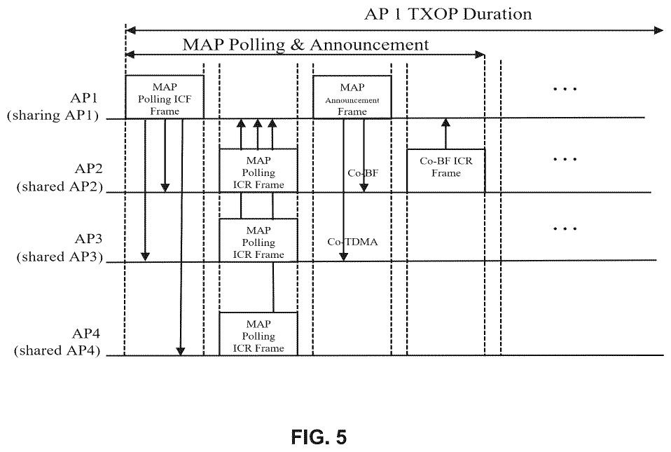

An example sequence of transmission is illustrated in FIG. 5, wherein a process for multi-access point (MAP) polling and announcement relative to access point (AP) transmission opportunity (TXOP) duration is illustrated, according to embodiments of the present disclosure. As illustrated, sharing AP1 sends a MAP polling ICF frame to shared AP2, shared AP3 and shared AP4. Each of these shared APs, respond to the sharing AP1 with an appropriate MAP polling ICR frame. The sharing AP1 subsequently transmits a MAP announcement frame to each of shared AP2 and shared AP3. The MAP announcement frame sent to share to shared AP2 defines coordinated beam forming (Co-BF) is to be used wherein the shared AP2 sends a Co-BF ICR frame to the sharing AP1. It is also noted that the MAP announcement frame sent to shared AP3 indicates coordinated time divisional multiple access (Co-TDMA) is to be used.

### Polled AP Selects MAP Coordination

According to embodiments, when one access point (AP) (e.g. sharing AP) obtains a transmission opportunity (TXOP), the sharing AP sends a multi-access point (MAP) polling initial control frame (ICF) frame to the other APs (e.g. shared APs) within the MAP coordination group in order to determine the shared APs willingness to participate in MAP coordinated transmission and to further gather information on the requested resources of the shared APs, provided that the shared APs are ready.

According to embodiments, the shared APs that are interested in participating in the MAP coordinated transmission must respond to the MAP polling ICF indicating their willingness and their requested resources, for example the shared APs can respond with a MAP polling initial control response (ICR).

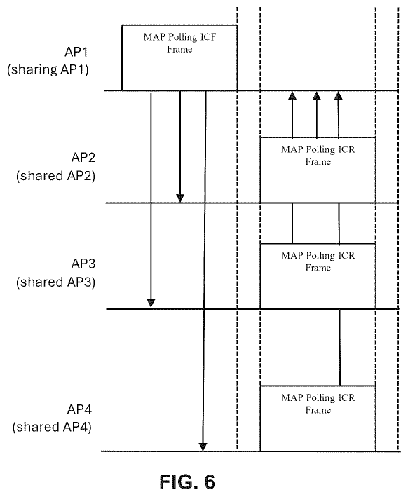

FIG. 6 illustrates a process for MAP polling for sharing APs including initial control frame (ICF) and initial control response (ICR), according to embodiments of the present disclosure. It is clear that this figure illustrates an enlarged view of the MAP polling process, according to embodiments.

According to embodiments, given that non-primary channel access (NPCA) support is optional, each shared AP can indicate its NPCA capability support to the sharing AP within its response to the MAP polling ICF via a MAP polling ICR. The MAP polling ICR can also information indicative of one or more of the shared AP's MAP readiness indication, required duration, bandwidth, transmit power, traffic indicator/access category (TID/AC), a low-latency indication, number of non-AP STAs the shared AP plans to serve, and a preferred MAPC scheme.

According to embodiments, as a result, one or more pieces of information shall be included in the MAP polling ICR. These one or more pieces of information can be indicative of one or more of: if NPCA is enabled or disabled. If NPCA is enabled, additional NPCA parameters may be included, which may include one or more of the NPCA primary channel location and bandwidth.

According to embodiments, based on feedback from the polled shared APs that is received by the sharing AP via the MAP polling ICR frames transmitted by the shared APs, the sharing AP can determine with which AP(s) of the shared AP is to share its full or partial TXOP. This determination can also be dependent on the appropriate coordination scheme(s) that may be used, for example Co-BF, Co-TDMA or the like.

According to embodiments, if the resource requirements (e.g., time, bandwidth, or power) of the polled AP(s) align with those supported by a MAP coordination (MAPC) scheme (e.g., Co-TDMA, Co-BF, Co-CSR, Co-OFDMA, etc.), the sharing AP may select that scheme for the shared AP(s), provided it also meets the sharing AP's needs and adheres to the constraints of the particular MAPC scheme. Further it is to be understood that both the sharing AP and the shared AP(s) support that MAPC scheme and the sharing AP and the shared AP(s) have already established an agreement for this particular MAPC scheme during the MAPC negotiation phase.

Conversely, if the resource requirements of the polled AP(s) do not match any supported MAPC scheme resources or constraints while additionally having indicated that NPCA is enabled, the sharing AP will direct the shared AP(s) to switch to their NPCA primary channel, provided NPCA is enabled.

According to embodiments, the sharing AP can then send an MAP announcement frame to the selected shared AP(s), including the NPCA-triggered AP(s) (e.g. the shared AP(s) triggered by the sharing AP to switch to their NPCA primary channel), indicating the supported coordination scheme(s) and allocating the necessary resources and/or parameters for the coordination.

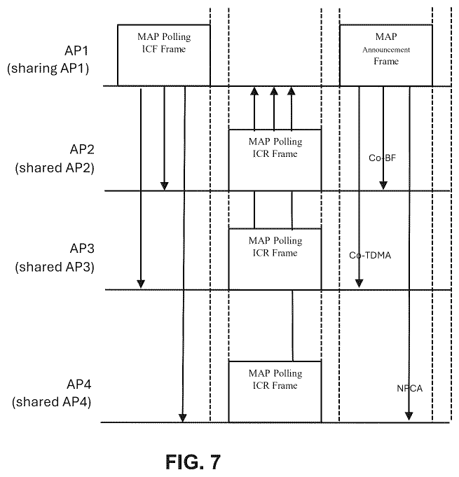

FIG. 7 illustrates a process for MAP polling and MAP announcement wherein a polled AP ops into MAP coordination, according to embodiments of the present disclosure.

According to embodiments for NPCA-triggered AP(s), the MAP announcement frame transmitted by the sharing AP to each of the selected shared APs, indicates information regarding one or more of NPCA duration and NPCA switching start time. It will be readily understood that other information may be transmitted in the MAP announcement frame, wherein this other information may be relevant to the specific scenario.

According to embodiments for NPCA-triggered and Co-OFDMA AP(s), the MAP announcement frame transmitted by the sharing AP to each of the selected shared APs, may specify a transmit power limit for the shared AP(s) to use while triggering their associated non-AP STAs to switch to a different resource unit (RU) or channel. This transmit power limit enables multiple shared APs to simultaneously trigger their associated non-AP STAs to switch their channels or RUs, while also allowing the sharing AP to initiate communication with its non-AP STAs without causing overlapping basic service set (OBSS) interference. This may be considered to be aligned with the same principle of Co-SR.

According to embodiments, the duration field of the MAP announcement frame is set to provide short network allocation vector (NAV) protection, which can enable the shared APs to respond promptly to the MAP announcement frame (for example as required in Co-BF) or can enable the shared APs to trigger their associated non-AP stations (STAs) to switch to a different channel (for example, in scenarios which can include NPCA or Co-OFDMA).

According to embodiments it is to be noted that for instances where multiple shared APs will be triggered to switch to their respective NPCA primary channel, the sharing AP confirms or determines that the sharing AP only triggers shared APs whose respective NPCA primary channels do not overlap.

According to embodiments, the buffer status report poll (BSRP) trigger frame, multi-user request-to-send (MU-RTS) trigger frame, or a new type trigger frame can be considered for use as the MAP announcement frame. In this embodiment, the MAP announcement frame format will follow the buffer status report poll (BSRP) trigger frame (for example, by setting the trigger type subfield value to ‘4’), (for example, by setting the trigger type subfield value to ‘4’), MU-RTS trigger frame (for example, by setting the trigger type subfield value to ‘3’), or a new type trigger frame (for example, by setting the trigger type subfield value to one of the reserved values, e.g., ‘9 to 15’). In some embodiments, if required, the shared AP(s) can send a multi-STA block acknowledgement (BA) as a MAP coordination scheme-specific initial control response (ICR).

According to some embodiments, a MAP coordination (MAPC) scheme-specific ICR may be required in cases where coordinated beam forming (Co-BF), coordinated orthogonal frequency division multiple access (Co-OFDMA) or coordinated non-primary channel access (Co-NPCA) are selected.

According to embodiments, when required, in order to allow multiple shared APs to respond simultaneously to the MAP announcement frame, the sharing AP can assign different resource unit (RU) allocations to for transmission of each of the AP responses to the MAP announcement frame. This configuration can enable the polled APs to transmit their triggered-based (TB) uplink physical layer protocol data unit (UL-PPDUs) (for example, transmit the MAP-specific ICRs) concurrently.

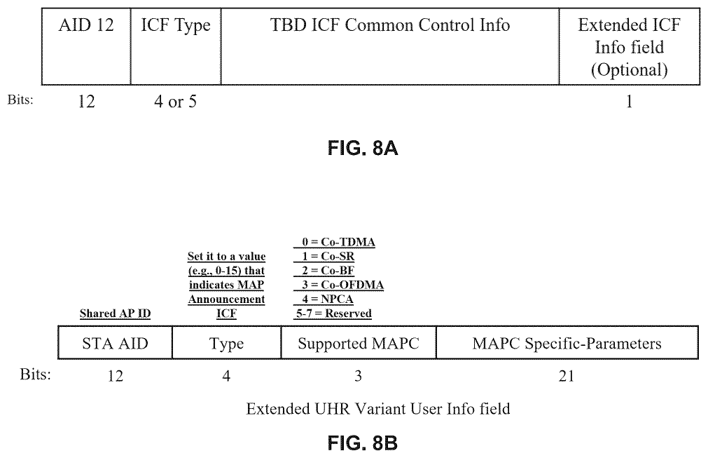

According to some embodiments the assigned RU allocation for each shared AP is specified in the RU allocation subfield of the respective ultra-high reliability (UHR) variant user info field, which can be identified by the assigned AP ID in the AID 12 subfield. FIG. 8B illustrates a format of an extended ultra-high reliability (UHR) variant user field, according to embodiments of the present disclosure.

According to some embodiments, an enhanced BSRP trigger frame is defined by adding an extended user info field which can be dedicated to ICF-type-specific common information. For example, one of the reserved bits in the common info field or the UHR variant special user info field may be repurposed to indicate the presence of this field. As another example, the presence of this field may be indicated by setting the value of the guard interval (GI) and the ultra-high reliability (UHR) long training field (LTF) type/TXOP sharing (TXS) mode subfield in the common info field of the trigger frame to ‘3’. FIG. 8A illustrates a format of an enhanced buffer status report poll (BSRP) trigger frame configuration, according to embodiments of the present disclosure. The extended special user info field can be formatted as follows: 1) AID 12: This field is used to specify STA ID or assigned shared AP ID during the MAPC negotiation phase; 2) ICF Type: This field is used to specify the type of user-specific control info, including options like MAP polling ICF, MAP announcement, coordinated beamforming (Co-BF) invite, coordinated beamforming (Co-BF) ICF, coordinated spatial reuse (Co-SR), coordinated TDMA (Co-TDMA), coordinated restricted target wake time (Co-r-TWT), In-device coexistence (IDC), dynamic sub-band operation (DSO), non-primary channel access (NPCA), dynamic power save (DPS), Co-BF or Co-SR trigger synchronization, and other types as would be readily understood. According to some embodiments, in an instance wherein the type-specific control info parameters exceeds the length of the user info field, one bit in the user info field can be used to indicate the presence of a second extended user info field, wherein this second extended user info field can be used for the identification of the additional type-specific control info parameters. Similarly, an enhanced MU-RTS trigger frame or new type trigger frame can be defined following the same method as defined elsewhere herein with respect to the enhanced BSRP trigger frame.

According to embodiments, having regard to the MAP announcement case, the main objective of the extended user info field is to carry the user/shared AP-specific information for the supported MAPC scheme and the transmission opportunity (TXOP) to be transmitted to the shared APs. For example, this user/shared AP-specific information can identify the supported MAPC scheme and the supported MAPC scheme-specific parameters, for example duration, bandwidth, and the like.

According to some embodiments, there is provided a new public action frame which can be used as the MAP announcement frame.

According to embodiments, for some MAPC schemes, e.g., Co-BF, it may be required that the shared AP(s) respond promptly to the announcement frame sent by the sharing AP, in order to declare the non-AP STAs the shared AP plans to serve using Co-BF (e.g., the number of these non-AP STAs and their respective STA IDs), indication of having enhanced multi-link single radio (eMLSR) or dynamic power saving (DPS) non-AP STAs to be served within the Co-BF transmission, and other information, e.g., precoding parameters or other information.

According to embodiments, the shared AP(s) may need to trigger their associated non-AP STAs to switch to a different RU or channel, when considering scenarios including Co-OFDMA or NPCA.

According to embodiments, in the case where Co-OFDMA is selected, within the trigger frame, the shared AP may indicate to its associated non-AP STAs, a new assigned RU allocation, switching start time, the Co-OFDMA duration and whether switching is enabled or disabled. In this embodiment, further information may be provided within the trigger frame as would be readily understood by a worker skilled in the art.

According to embodiments, in the case where NPCA is selected, within this trigger frame, the shared AP may indicate to its associated non-AP STAs whether NPCA switching is enabled or disabled, the NPCA switching start time and the NPCA duration. In this embodiment, further information may be provided within the trigger frame as would be readily understood by a worker skilled in the art.

According to embodiments, in the case where the MAP scheme-specific ICR frame is a response to be transmitted to the sharing AP, the frame format can be selected to be configured as a multi-STA BA frame or a new public action frame.

According to embodiments, in the case where the MAP scheme-specific ICR frame is a response to be transmitted to the sharing AP together with a trigger for the shared AP's associated non-APs, the frame format can be selected to be configured as a multi-STA BA frame.

According to embodiments, in the case where the MAP scheme-specific ICR frame is used as a trigger for the non-APs associated with the shared AP, the frame format can be selected to be configured as an appropriate trigger frame type. An appropriate trigger frame type can be selected from a multi-user block acknowledgement request (MU-BAR) trigger frame (e.g., by setting the trigger type subfield value to ‘2’), a multi-user request-to-send (MU-RTS) trigger frame (e.g., by setting the trigger type subfield value to ‘3’), a buffer status report poll (BSRP) trigger frame or a new type trigger frame (e.g., by setting the trigger type subfield value to one of the reserved values between ‘9-15’). In some embodiments, a buffer status report poll (BSRP) trigger frame is selected wherein the Trigger Type subfield value to ‘4’.

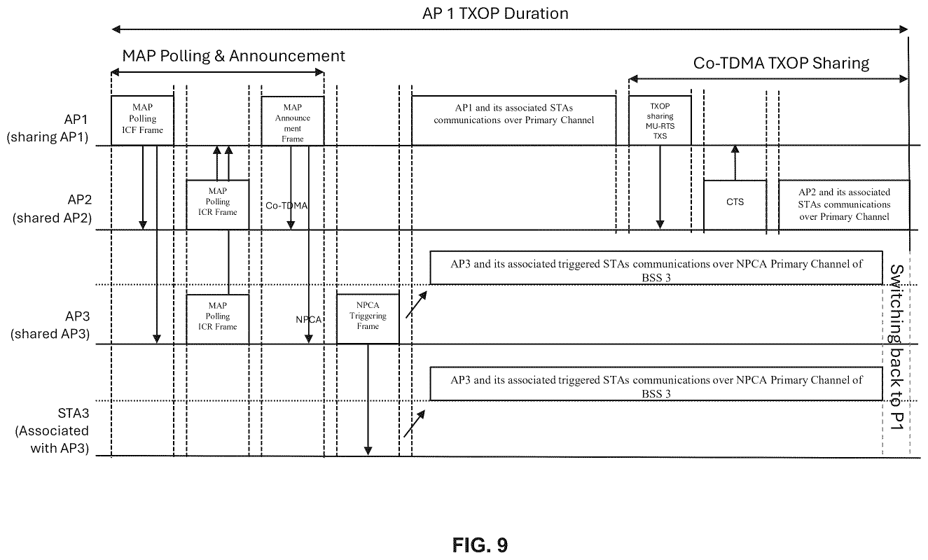

FIG. 9 illustrates a process for MAP coordinated time division multiple access (Co-TDMA) with NPCA, according to embodiments of the present disclosure. In the embodiment illustrated in FIG. 9, the sharing AP1 is coordinating with shared AP2 using Co-TDMA, while triggering the shared AP3 to switch to its NPCA primary channel in order to obtain the benefit of a longer TXOP duration. It is to be understood that both Co-TDMA and NPCA transmissions are carried out over different channels.

According to embodiments, it is to be noted that for the example illustrated in FIG. 9, the sharing AP may allow more shared APs to participate in this MAP coordinated transmission by further supporting Co-OFDMA. For instance, the sharing AP may coordinate with an additional shared AP using Co-OFDMA.

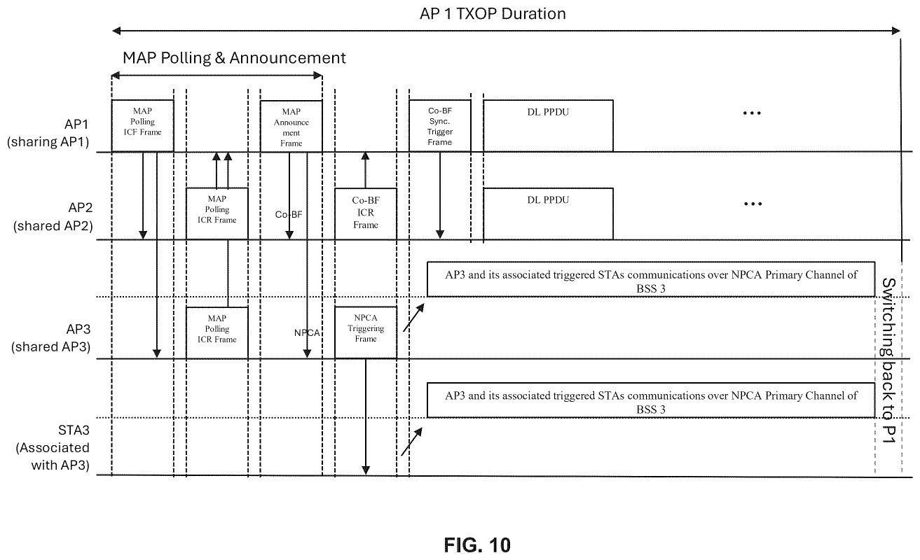

FIG. 10 illustrates a process for MAP coordinated beamforming (Co-BF) with NPCA, according to embodiments of the present disclosure. In the embodiment illustrated in FIG. 9, the sharing AP1 is coordinating with shared AP2 using Co-BF, while triggering the shared AP3 to switch to its NPCA primary channel in order to obtain the benefit of longer TXOP duration. It is to be understood that both Co-BF and NPCA transmissions are carried out over different channels.

According to embodiments, it is to be noted that for the example illustrated in FIG. 10, the sharing AP may allow more shared APs to participate in this MAP coordinated transmission by further supporting Co-OFDMA. For instance, the sharing AP may coordinate with an additional shared AP using Co-OFDMA.

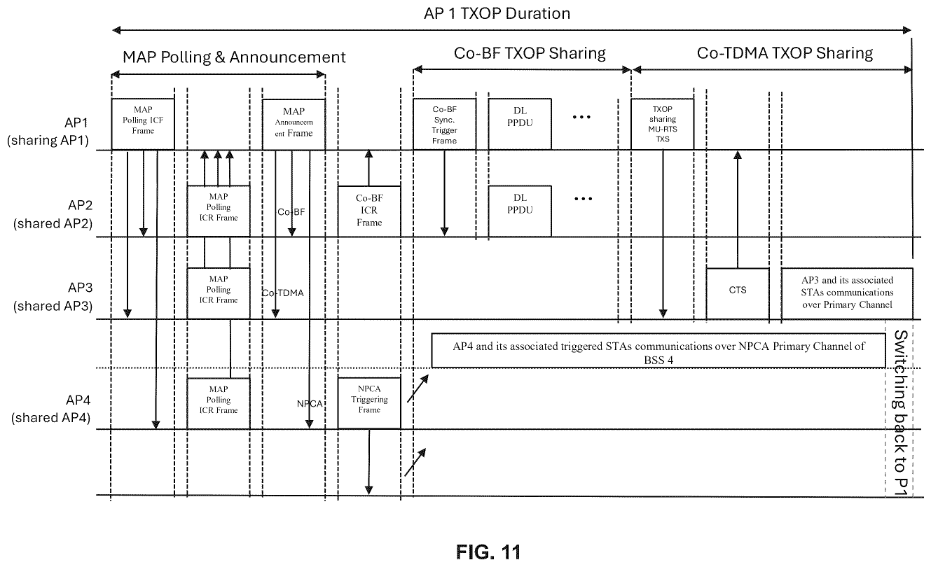

FIG. 11 illustrates a process for MAP Co-TDMA and Co-BF with NPCA, according to embodiments of the present disclosure. In the embodiment illustrated in FIG. 9, the sharing AP1 is splitting its TXOP duration by coordinating with shared AP2 using Co-BF in the first part, while assigning the remaining TXOP duration to the shared AP3 using Co-TDMA. At the same time, the sharing AP triggers the shared AP3 to switch to its NPCA primary channel in order to obtain the benefit of a longer TXOP duration.

According to embodiments, it is to be noted that for the example illustrated in FIG. 11, the sharing AP may allow more shared APs to participate in this MAP coordinated transmission by supporting Co-OFDMA. For instance, the sharing AP may coordinate with an additional shared AP using Co-OFDMA.

According to embodiments, the sharing AP1 may coordinate with shared AP2 using Co-SR, while triggering the shared AP3 to switch to its NPCA primary channel in order to obtain the benefit of a longer transmission opportunity (TXOP) duration. It is to be understood that both Co-SR and NPCA transmissions are carried out over different channels. The sharing AP may allow more shared APs to participate in this MAP coordinated transmission by further supporting Co-OFDMA. For instance, the sharing AP may coordinate with an additional shared AP using Co-OFDMA.

### MAP Coordination for NPCA Parameters Update

According to embodiments it is to be noted that for instances where multiple shared APs will be triggered to switch to their respective NPCA primary channel, the sharing AP confirms or determines that the sharing AP only triggers shared APs whose respective NPCA primary channels do not overlap.

According to embodiments, neighboring APs with overlapping NPCA primary channels may coordinate with each other to recommend updating their NPCA primary channel to non-overlapping channel locations.

According to embodiments, the coordination between the neighboring OBSS APs to update their NPCA primary channel update can be carried out by exchanging public action frames.

According to embodiments, one or more of the reserved values of the public action field values may be repurposed for the public action frames exchanged between neighboring OBSS for parameters (e.g., NPCA and bandwidth expansion) coordination.

According to embodiments, the public action frames exchanged between neighboring OBSS APs may carry a MAP parameter negotiation/notify element.

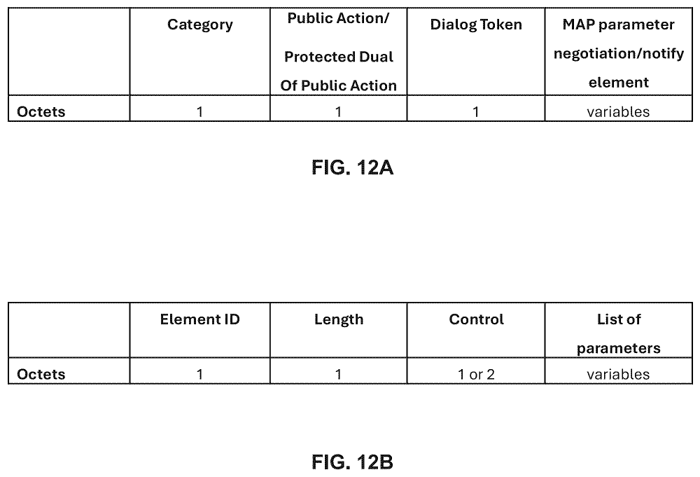

According to embodiments, the public action frame for parameters negotiation/notify can be formatted as presented in FIG. 12A.

According to embodiments, MAP parameters negotiation element can be formatted as presented in FIG. 12B. In this example, the control field includes an indication of the presence of the parameters subject to update, negotiation, or coordination between two or more APs. If the present bit for any parameter is set to 1, the parameter list can include a recommendation for its values. One such parameter may be the NPCA parameters. If the NPCA channel update present bit is set to 1, the list can include recommendations for NPCA parameter values, such as the NPCA primary channel location and/or bandwidth. Another example of such a parameter may be the bandwidth expansion parameters. If the bandwidth expansion update present bit is set to 1, the list can include recommendations for bandwidth expansion, such as bandwidth expansion value and duration. Additionally, the control field may contain a 2-bit or 3-bit request type subfield, which can indicate whether the request is to suggest, demand, accept, decline, notify, or propose an alternative.

According to embodiments, one AP may expand the operating bandwidth and subsequently notify its associated non-AP STAs and other OBSS APs. The one AP can notify of the expansion of the operating bandwidth by transmission of the bandwidth expansion value and duration via beacon frames and public action frames, respectively.

According to embodiments, one AP may send a request to an OBSS neighbor AP to update its NPCA primary channel to a different location. The OBSS AP can then respond to this request by either accepting, declining, or suggesting alternative NPCA parameters.

According to embodiments, one AP may update its NPCA parameters (e.g., NPCA primary channel location and bandwidth), and subsequently notify its associated non-AP STAs, as well as other OBSS APs that have an overlapping NPCA primary channel, of the updated NPCA parameters.

According to embodiments, after the associating AP announces and updates its NPCA parameters, each associated non-AP STA can to report its NPCA enable/disable mode, NPCA channel switching delay, and NPCA channel switching back delay to its associating AP. The associating AP can take these parameters into consideration while initiating a communication with its associated non-AP STAs over the NPCA primary channel.

### Polled AP Declines MAP Coordination and Selects NPCA

According to embodiments, when one access point (AP) (e.g. sharing AP) obtains a transmission opportunity (TXOP), the sharing AP sends a multi-access point (MAP) polling initial control frame (ICF) frame to the other APs (e.g. shared APs) within the MAP coordination group in order to determine the shared APs willingness to participate in MAP coordinated transmission and to further gather information on the requested resources of the shared APs, provided that the shared APs are ready.

According to embodiments, the shared APs that are interested in participating in the MAP coordinated transmission must respond to the MAP polling ICF indicating their willingness and their requested resources, for example the shared APs can respond with a MAP polling initial control response (ICR).

According to embodiments, if the polled shared AP is unwilling to participate in MAP coordination with the sharing AP but intends to switch or trigger its associated non-AP STAs to switch to the NPCA primary channel, the particular shared AP simply ignores the MAP polling ICF.

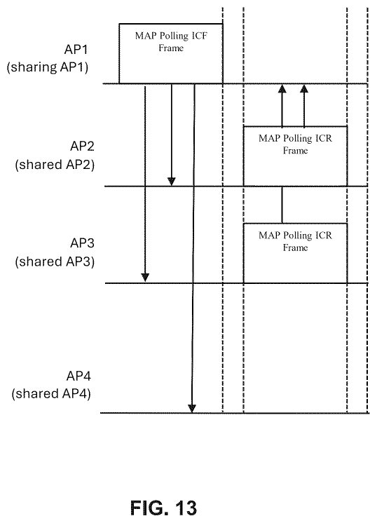

FIG. 13 illustrates a process for MAP polling for sharing APs including ICF and ICR, wherein a polled AP declines MAP coordination while choosing NPCA, according to embodiments of the present disclosure.

According to embodiments, non-AP STAs that are associated with the shared AP, will wait for a duration equal to the MAP polling ICR transmission plus the short interframe space (SIFS) time. During this waiting period, these non-AP STAs can only detect the control frame exchange (e.g., MAP polling ICF and ICR) between other OBSS APs. This detection by the non-AP STAs associated with the shared AP, will trigger these non-AP STAs associated with the shared AP to switch to the NPCA primary channel. It is to be noted that this consideration and action aligns with a potential requirement that STAs must detect an OBSS control frame to initiate switching to the NPCA primary channel.

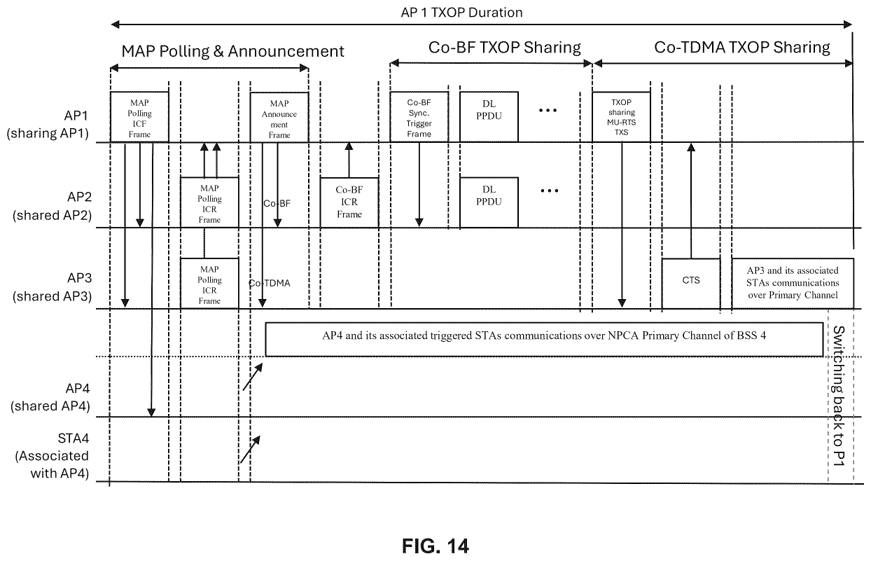

According to embodiments, the shared AP and non-AP STAs that are associated with the shared AP, can detect the NPCA duration that matches the TXOP duration specified in the extended special user info field of the MAP Polling ICF. This can allow the shared AP and its associated non-AP STAs to switch to their NPCA primary channel at an earlier time. For example, the shared AP and its associated non-AP STAs do not have to wait until the MAP announcement & MAP scheme-specific information exchange (see FIG. 14).

FIG. 14 illustrates a process for MAP Co-TDMA and Co-BF with NPCA, wherein a polled AP declines MAP coordination while choosing NPCA, according to embodiments of the present disclosure.

### Polled AP Declines MAP Coordination and Declines NPCA

According to embodiments, when one access point (AP) (e.g. sharing AP) obtains a transmission opportunity (TXOP), the sharing AP sends a multi-access point (MAP) polling initial control frame (ICF) frame to the other APs (e.g. shared APs) within the MAP coordination group in order to determine the shared APs willingness to participate in MAP coordinated transmission and to further gather information on the requested resources of the shared APs, provided that the shared APs are ready.

According to embodiments, the shared APs that are interested in participating in the MAP coordinated transmission must respond to the MAP polling ICF indicating their willingness and their requested resources, for example the shared APs can respond with a MAP polling initial control response (ICR).

According to embodiments, if the polled shared AP is unwilling to participate in MAP coordination with the sharing AP and the polled shared AP further does not wish to switch or trigger its associated non-AP STAs to switch to the NPCA primary channel, the polled shared AP must respond to the MAP Polling ICF by sending a MAP polling ICR indicating its unwillingness to participate. According to embodiments, indication of unwilling to participate can be conveyed by setting the MAPC readiness or availability indication bit within the MAP Polling ICR frame to zero.

According to embodiments, the non-AP STAs associated with the polled AP will detect the MAP ICF and ICR exchange between the associated shared AP and an OBSS AP but the non-AP STAs associated with the polled AP will not be triggered to switch to the NPCA primary channel. For example, it is to be noted that in order for a STA to be triggered to initiate to switch to the NPCA primary channel, the STA must detect an OBSS control frame exchange.

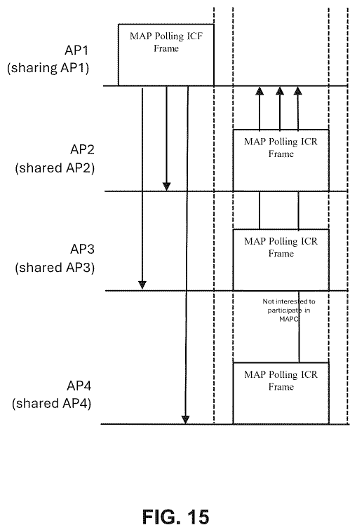

FIG. 15 illustrates a process for MAP polling for sharing APs including ICF and ICR, wherein a polled AP declines MAP coordination and further declines NPCA, according to embodiments of the present disclosure.

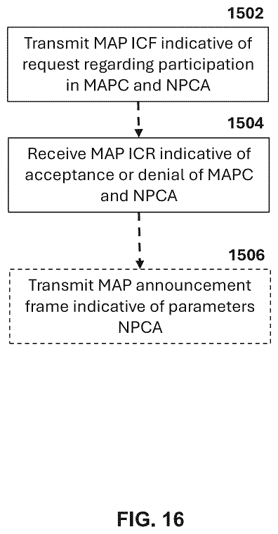

FIG. 16 illustrates a method for multi-access point (MAP) coordination, according to embodiments of the present disclosure. The method includes transmitting 1502, by a sharing access point (AP) to a shared AP, a MAP polling initial control frame (ICF), the MAP ICF indicative of a request regarding participation of the sharing AP in MAP coordination and non-primary channel access (NPCA). The method further including receiving 1504, by the sharing AP from the shared AP, a MAP polling initial control response (ICR), the MAP ICR indicative of acceptance or denial of one or more of MAP coordination and NPCA, by the shared AP.

In some embodiments, the MAP ICR further includes MAPC and NPCA capabilities associated with the shared AP.

In some embodiments, upon receipt, by the sharing AP, of a MAP ICR indicative of acceptance of one or more of MAP coordination and NPCA, the method further includes transmitting 1506, by the sharing AP to the shared AP(s), a MAP announcement frame, the MAP announcement frame indicative of parameters associated with the selected MAP coordination scheme or NPCA.

In some embodiments, upon receipt by the sharing AP, of the MAP announcement frame, the method further includes transmitting, by the shared AP to a station (STA) associated with the shared AP, a NPCA trigger frame.

In some embodiments, the MAP announcement frame is configured as a buffer status report poll (BSRP) frame.

In some embodiments, when another shared AP receives the MAP polling ICF and the another shared AP is unresponsive to the MAP polling ICF, the method further includes switching, by the another shared AP, to a NPCA primary channel associated with the another shared AP, prior to transmission of a MAP announcement frame by the sharing AP.

According to embodiments, there is provided a method for the integration of NPCA into the MAP coordination. This may enhance resource allocation, improve throughput based on real-time conditions, reduce overlapping basis service set (OBSS) interference, and support more APs and non-AP STAs and improve network capacity in dense environments.

According to embodiments, there is provided a method for support for multiple MAP coordination schemes within a single transmission opportunity (TXOP). This may increase flexibility and address diverse AP requirements simultaneously.

According to embodiments, there is provided an adaptive framework considering both sharing APs and shared APs. This may balance transmission requirements, which may improve efficiency across all APs

According to embodiments, there is provided a means for scalability for more APs and STAs. This may support more coordinating APs without compromising performance.

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A method for multi-access point (MAP) coordination, the method comprising:
transmitting, by a sharing access point (AP) to a shared AP(s), a MAP polling initial control frame (ICF), the MAP ICF indicative of a request regarding participation of the sharing AP in MAP coordination and non-primary channel access (NPCA);
receiving, by the sharing AP from the shared AP, a MAP polling initial control response (ICR), the MAP ICR indicative of acceptance or denial of one or more of MAP coordination and NPCA, by the shared AP.

2. The method according to claim 1, wherein the MAP ICR further includes NPCA capabilities associated with the shared AP.

3. The method according to claim 1, upon receipt of the MAP ICR indicative of acceptance of one or more of MAP coordination and NPCA, the method further comprising:
transmitting, by the sharing AP to the shared AP, a MAP announcement frame(the MAP announcement frame indicative of parameters associated with the selected MAP coordination scheme or NPCA.

4. The method according to claim 3, upon receipt of the MAP announcement frame, the method further comprising:
transmitting, by the shared AP to a non-AP station (STA) associated with the shared AP, a NPCA trigger frame.

5. The method according to claim 4, wherein the NPCA trigger frame is indicative of whether NPCA switching is enabled or disabled, the NPCA switching start time and the NPCA duration.

6. The method according to claim 3, wherein the MAP coordination scheme is selected from any one of coordinated beamforming (Co-BF), coordinated time division multiple access (Co-TDMA), coordinated orthogonal frequency division multiple access (Co-OFDMA), and coordinated spatial reuse (Co-SR).

7. The method according to claim 3, wherein when multiple shared access points (APs) are to be triggered to switch to respective non-primary channel access (NPCA) primary channels, the sharing AP only triggers shared APs whose respective NPCA primary channels do not overlap.

8. The method according to claim 3, wherein the sharing AP assigns different resource unit (RU) allocations to for transmission of each of the AP responses to the MAP announcement frame to allow multiple shared APs to respond simultaneously to the MAP announcement frame.

9. The method according to claim 3, wherein the MAP announcement frame is configured as a buffer status report poll (BSRP) frame or a multi-user request-to-send (MU-RTS) trigger frame.

10. The method according to claim 1, wherein another shared AP receives the MAP ICF and wherein the another shared AP is unresponsive to MAP ICF, the method further comprising:
switching, by the another shared AP and a non-AP STAs associated with the another shared AP, to a NPCA primary channel associated with the another shared AP, prior to transmission of a MAP announcement frame by the sharing AP.

11. The method according to claim 10, further comprising detecting, by the non-AP STAs, an overlying basic service set (OBSS) control frame exchange in order to initiate switching to the NPCA primary channel.

12. The method according to claim 10, further comprising detecting, by the shared AP and the non-AP STAs, a NPCA duration that matches a transmission opportunity (TXOP) duration specified in the MAP ICF.

13. The method according to claim 1, wherein another shared AP receives the MAP ICF and wherein the another shared AP is responsive to the MAP polling ICF, by sending the MAP ICR indicating its unwillingness to participate, the method further comprising:
refraining from switching, by the another shared AP and the non-AP STAs associated with the another shared AP, to a NPCA primary channel associated with the another shared AP.

14. The method according to claim 13, where the indicating of unwilling to participate comprising setting an availability indication bit within the MAP ICR frame to zero.

15. The method according to claim 1, wherein the MAP ICR further includes one or more of: a MAP coordination readiness indication, required duration, bandwidth, transmit power, traffic indicator/access category (TID/AC), a low-latency indication, number of non-AP STAs the shared AP plans to serve, and a preferred MAP coordination scheme.

16. The method according to claim 1, wherein neighboring APs with overlapping NPCA primary channels may coordinate with each other to recommend updating their NPCA primary channel to non-overlapping channel locations.

17. The method according to claim 16, where the coordination between the neighboring APs to update their NPCA primary channel update is carried out by exchanging public action frames.

18. The method according to claim 17, wherein the public action frames exchanged between neighboring APs may carry a MAP parameter negotiation/notify element.

19. One or more circuits for performing a method for multi-access point (MAP) coordination, the method comprising:
transmitting, by a sharing access point (AP) to a shared AP(s), a MAP polling initial control frame (ICF), the MAP ICF indicative of a request regarding participation of the sharing AP in MAP coordination and non-primary channel access (NPCA);
receiving, by the sharing AP from the shared AP, a MAP polling initial control response (ICR), the MAP ICR indicative of acceptance or denial of one or more of MAP coordination and NPCA, by the shared AP.

20. One or more non-transitory computer-readable storage devices comprising computer-executable instructions, wherein the instructions, when executed, cause one or more circuits to perform a method for multi-access point (MAP) coordination, the method comprising:
transmitting, by a sharing access point (AP) to a shared AP(s), a MAP polling initial control frame (ICF), the MAP ICF indicative of a request regarding participation of the sharing AP in MAP coordination and non-primary channel access (NPCA);
receiving, by the sharing AP from the shared AP, a MAP polling initial control response (ICR), the MAP ICR indicative of acceptance or denial of one or more of MAP coordination and NPCA, by the shared AP.
